(19) United States
(12) Patent Application Publication
(10) Pub. No.: US 2026/0261332 A1
(43) Pub. Date: Sep. 3, 2026

(54) DYNAMIC HYBRID BEAM TRACKING SYSTEM FOR SATELLITE COMMUNICATIONS

(71) Applicant: YTTEK Technology Corp., Zhubei City (TW)

(72) Inventor: CHUNG-LIEN HO, Zhubei City (TW)

(21) Appl. No.: 19/390,781

(22) Filed: Nov. 17, 2025

Related U.S. Application Data
(60) Provisional application No. 63/765,388, filed on Feb. 28, 2025.

(51) Int. Cl. H04B 7/185

(52) U.S. Cl. CPC H04B 7/18519; H04B 7/18513

(57) ABSTRACT

The present invention discloses a dynamic hybrid beam tracking system for satellite communications. The system classifies beam tracking into three operating modes based on a current reference antenna orientation stored in memory, an antenna orientation updated by a mechanical triple-axis shaft, an incoming path direction of a satellite relative to an antenna broadside direction of a user terminal, a received signal strength indicator, and a predefined antenna field-of-view. The three operating modes include: a first mode employing coarse beam tracking at a low sampling rate for large-scale tracking; a second mode employing fine beam tracking at the same low sampling rate for medium-scale tracking; and a third mode employing fine beam tracking at a high sampling rate for small-scale tracking. The system thereby achieves precise and adaptive beam alignment, enhancing tracking accuracy and overall satellite communication performance.

### BACKGROUND OF THE INVENTION

This application claims the priority benefit of provisional patent application No. 63/765,388 titled “DYNAMIC HYBRID BEAM TRACKING SYSTEM FOR SATELLITE COMMUNICATIONS” filed on 28 Feb. 2025, the disclosure of which is incorporated by reference herein in its entirety.

### FIELD OF INVENTION

The present invention relates to the field of satellite communications (SATCOM), and more particularly to a dynamic hybrid beam tracking system designed for satellite communications.

### DESCRIPTION OF THE RELATED ART

Satellite communications primarily involve the transmission of signals through electromagnetic beams between ground-based user terminals (UTs) and target satellites in Earth orbit. The UTs include both fixed and mobile communication equipment, wherein the mobile communication equipment includes, but is not limited to, devices installed on movable platforms such as ships and vehicles operating on the Earth's surface. Beam alignment between an antenna of the UT and a target satellite is essential to ensure accurate link transmission.

The antenna utilizes beam directivity to focus signal toward the target satellite, thereby ensuring accurate link transmission. When relative motion occurs between the antenna and the target satellite, the antenna must track the satellite to maintain beam alignment by continuously directing the beam toward the moving target satellite.

### SUMMARY OF THE INVENTION

The main purpose of the present invention is to provide a dynamic hybrid beam tracking system for satellite communications (SATCOM), particularly a system in which a user terminal (UT) performs antenna operations to achieve beam alignment with a target satellite.

In order to achieve this purpose, the present invention employs the following technical solution.

A dynamic hybrid beam tracking system for SATCOM operates when an antenna of the UT located on the Earth's surface is in relative motion with respect to a target satellite in orbit, thereby enabling dynamic beam tracking of the antenna to maintain beam alignment with the target satellite.

The system operates under a condition in which the antenna has established a connection with the target satellite through an initial search process, and dynamically determines a beam tracking mode based on a current reference antenna orientation stored in memory, an antenna orientation updated via a mechanical triple-axis shaft, an incoming path direction of the satellite relative to an antenna broadside direction of the UT, a received signal strength indicator (RSSI), and a predefined tracking mode and field-of-view (FoV).

The beam tracking modes include:
a first mode, in which a coarse beam is used for large-scale tracking at a first sampling rate;
a second mode, in which a fine beam is used for medium-scale tracking at the first sampling rate; and
a third mode, in which a fine beam is used for small-scale tracking at a second sampling rate, wherein the second sampling rate is higher than the first sampling rate.

The reference antenna orientation is determined according to three axes of the antenna, and the reference antenna orientation corresponds to a previous antenna orientation obtained t sampling points prior to a current time, wherein t represents the number of sampling points.

The present invention employs the first mode, the second mode, and the third mode in conjunction with the first sampling rate or the second sampling rate, respectively, to activate rapid mechanical coarse adjustment when a large-scale error occurs, switch to electrical fine tracking after the error is reduced, and then perform step tracking at the higher second sampling rate. As a result, the overall response time is shortened, beam reacquisition time is reduced, and tracking speed and responsiveness are improved.

### BRIEF DESCRIPTION OF THE DRAWINGS

FIG. 1 illustrates a frame structure of a beam tracking system;

FIG. 2 illustrates a schematic diagram of beam tracking performed by an antenna of a user terminal (UT);

FIG. 3 illustrates tracking scopes of the hybrid beam tracking system;

FIG. 4 illustrates a beam tracking process; and

FIG. 5 illustrates a continuation of the beam tracking process shown in FIG. 4.

### DETAILED DESCRIPTION OF THE PREFERRED EMBODIMENTS

The accompanying drawings illustrate preferred embodiments of a dynamic hybrid beam tracking system for satellite communications (SATCOM). However, these embodiments are provided for illustrative purposes only and are not intended to limit the scope of the invention.

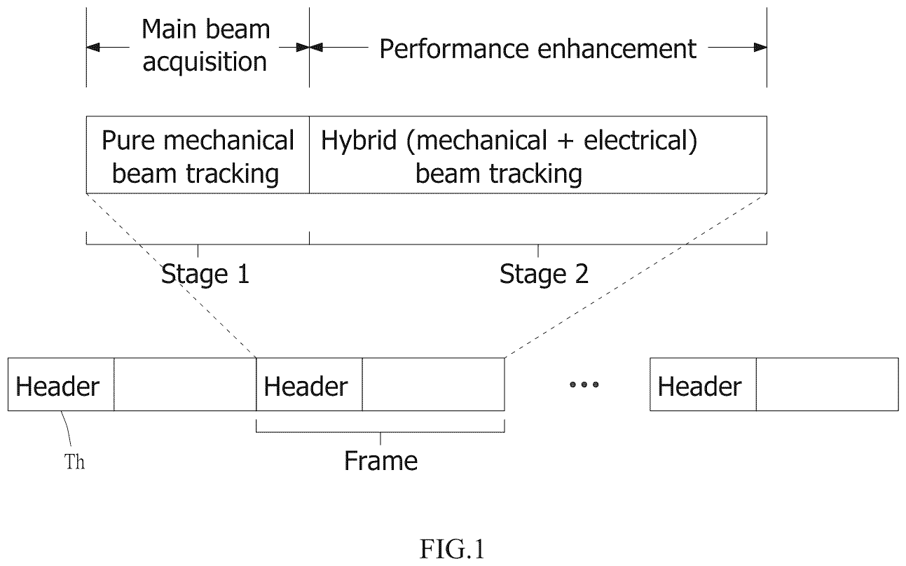

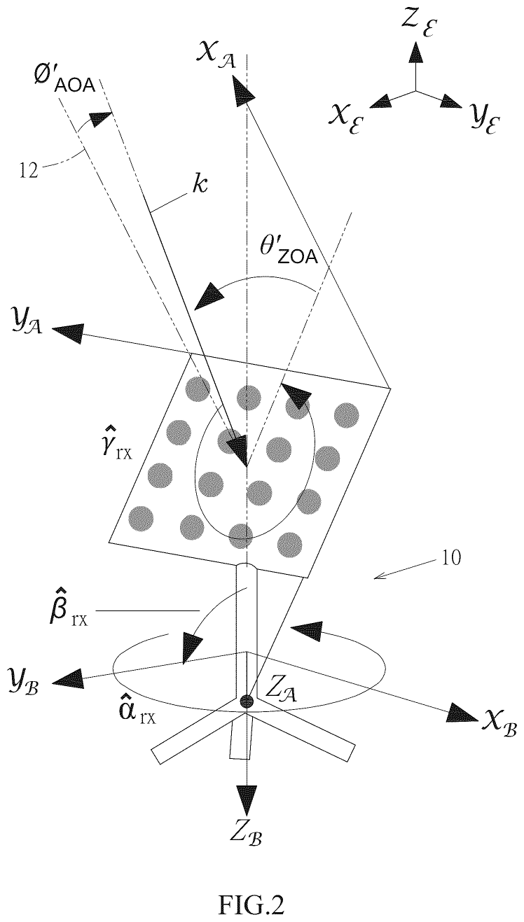

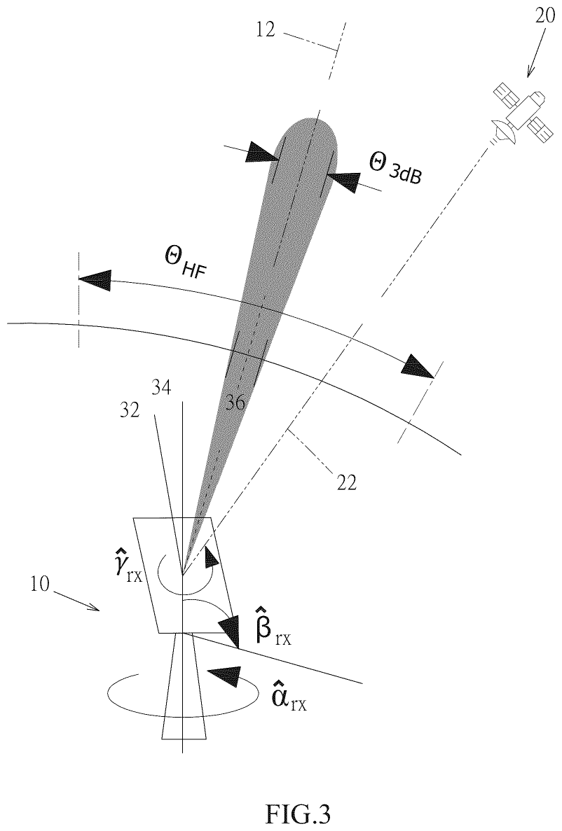

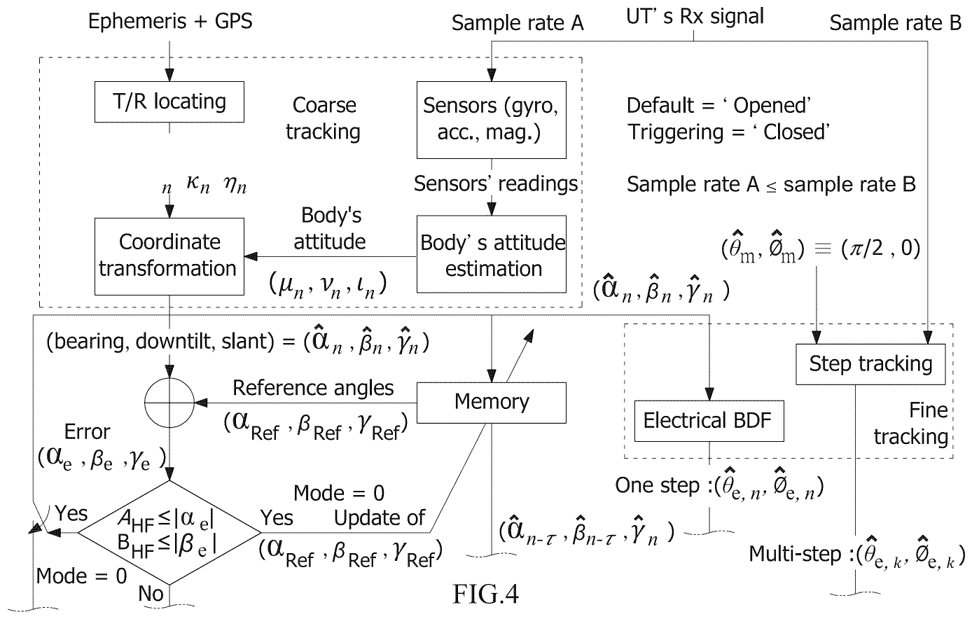

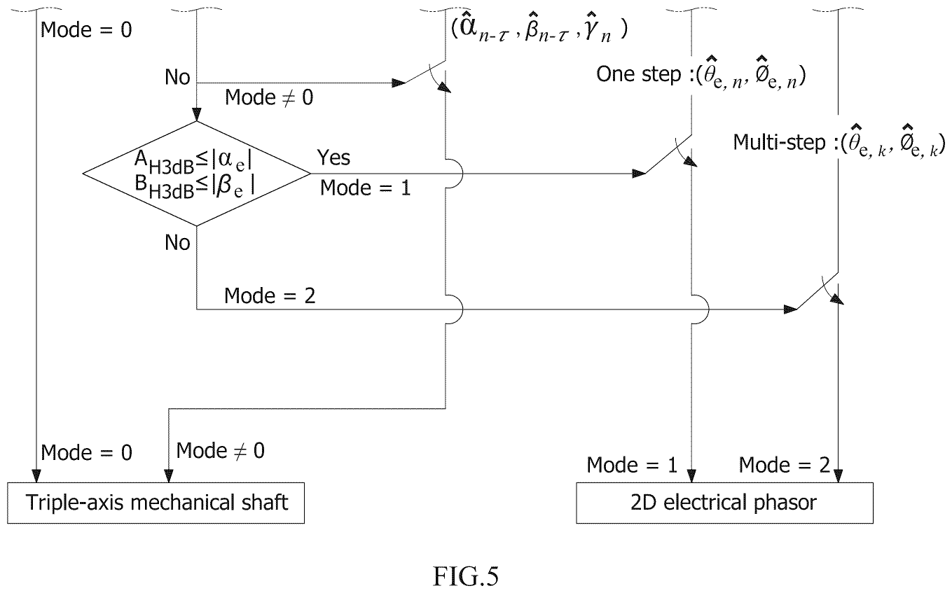

As illustrated in FIGS. 1 to 5, the dynamic hybrid beam tracking system for satellite communications (SATCOM) operates when an antenna 10 of a user terminal (UT), located on the Earth's surface, is in relative motion with respect to a target satellite 20 in orbit. The antenna 10 dynamically performs hybrid beam tracking to align its beam with the target satellite 20.

The dynamic hybrid beam tracking system operates under a condition in which the antenna 10 has established a link connection with the target satellite 20 through an initial search process.

Tracking of the target satellite 20 by the antenna 10 is sequentially performed through a pure mechanical tracking, a pure electrical tracking, and a hybrid tracking.

The pure mechanical tracking is performed using a fixed-phase mechanical triple-axis shaft to obtain an antenna broadside direction (\hat{θ}ₒ,\hat{φ}ₒ) of a horn antenna, where (\hat{θ}ₒ,\hat{φ}ₒ)=(\hat{θ}ₘ,\hat{φ}ₘ)≡(π/2, 0). This method is characterized by low accuracy, no scanning loss at large angles, slow tracking speed, wear-and-tear issues, and low cost.

The pure electrical tracking is based on the results of the pure mechanical tracking and is performed using a dynamically adjustable electrical phase shifter to obtain (\hat{θ}ₒ,\hat{φ}ₒ)=(\hat{θ}ₑ,\hat{φ}ₑ). This method is characterized by high accuracy, scanning loss at large angles, fast tracking speed, no wear-and-tear issues, and high cost.

The hybrid tracking is jointly performed by both the mechanical triple-axis shaft and the electrical phase shifter to achieve a balance between the pure mechanical tracking and the pure electrical tracking.

The hybrid tracking is performed within a selected tracking scope using both mechanical and electrical adjustments. Specifically, a one-step mechanical adjustment is first performed for a large-scale tracking scope 32 by, for example, programmed tracking, followed by either a one-step electrical adjustment by programmed tracking or a multi-step electrical adjustment by, for example, step tracking within a small-scale tracking scope 36.

The one-step mechanical adjustment and the electrical adjustment are both programmed tracking operations based on the geographical locations of the target satellite 20 and the antenna 10.

The multi-step electrical adjustment is performed based on a received signal strength indicator (RSSI) and previous tracking results using a step-tracking method, wherein the step tracking method may include at least one of the following: a direct search method, a gradient method, or a quadratic approximation method.

In a preferred embodiment, the dynamic hybrid beam tracking system is implemented during the hybrid tracking process, which consists of a first stage and a second stage. In the first stage, a main beam acquisition is performed through a coarse tracking mechanism using pure mechanical beam tracking within a predefined frame header Tₕ. This stage can be conducted within a 3 dB beamwidth to meet minimum link budget requirements.

The second stage focuses on performance enhancement by employing both coarse and fine beam adjustments to achieve hybrid beam tracking by combining mechanical and electrical components. This stage further enhances tracking performance, improving tracking accuracy, reducing tracking time, and preventing wear-and-tear issues.

The hybrid beam tracking includes two successive steps. Step one is a mechanical adjustment operation using the mechanical triple-axis shaft, which roughly adjusts a bearing angle \ddot{α}ᵣₓ, a down-tilt angle \hat{β}ᵣₓ, and a slant angle \hat{γ}ᵣₓ of the antenna 10. When the target satellite 20 is in geostationary orbit, the slant angle of the antenna 10 is adjusted only through mechanical operation. It is noted that electrical adjustment of the slant angle cannot provide additional degrees-of-freedom (DoF) in the x-axis.

Step two, which follows step one, involves an electrical adjustment using a phased array antenna having a uniform planar array (UPA) to fine-tune a beam direction k of the antenna 10 to align with an incoming path direction 22 of the target satellite 20, wherein the incoming angles include an angle-of-arrival (AOA) φ′_{ZOA} and a zenith-of-arrival (ZOA) θ′_{ZOA}.

A two-dimensional electronic phase shifter provides additional degrees-of-freedom (DoF) in a y-z plane, thereby further improving the accuracy of the beam pointing of the antenna 10 toward the AOA and the ZOA.

During the mechanical adjustment, a mechanical triple-axis shaft of the antenna 10, including a bearing axis, a down-tilt axis, and a slant axis, respectively rotates to adjust the three-axis orientation (\hat{α}ᵣₓ,\hat{β}ᵣₓ,\hat{γ}ᵣₓ) of the antenna 10. A pointing error (θₑ,φₑ)≡(\hat{θ}ₘ−θ′_{ZOA},\hat{φ}ₘ−φ′_{AOA}) of the antenna 10 relative to an incoming direction (θ′_{ZOA}, φ′_{AOA}) of the target satellite 20 is a function of the three-AOA axis orientation (\hat{α}ᵣₓ,\hat{β}ᵣₓ,\hat{γ}ᵣₓ), i.e., (θ′_{ZOA}, φ′_{AOA})=f(\hat{α}ᵣₓ,\hat{β}ᵣₓ,\hat{γ}ᵣₓ). By adjusting the bearing axis, down-tilt axis, and slant axis of the antenna 10 to modify its three-axis orientation (\hat{α}ᵣₓ,\hat{β}ᵣₓ,\hat{γ}ᵣₓ), an equivalent beam direction (\hat{θ}ₘ,\hat{φ}ₘ)≡(π/2,0) with a fixed phase can be obtained, enabling the antenna 10 to point toward the target satellite 20 as accurately as possible.

The electrical adjustment obtains an equivalent beam direction (\hat{θ}ₑ,\hat{φ}ₑ) with a dynamic phase through an electrical phase shifter of the antenna 10. The equivalent beam direction (\hat{θ}ₑ,\hat{φ}ₑ) with the dynamic phase is a function of the antenna three-axis orientation (bearing, down-tilt, and slant), i.e., (\hat{θ}ₑ,\hat{φ}ₑ)=f(\hat{α}ᵣₓ,\hat{β}ᵣₓ.\hat{γ}ᵣₓ). By combining the mechanical adjustment and the electrical adjustment, an overall beam direction (\hat{θ}ₒ,\hat{φ}ₒ) is obtained. The electrical adjustment performed by the electrical phase shifter of the antenna 10 generates the equivalent beam direction (\hat{θ}ₑ,\hat{φ}ₑ) with the dynamic phase such that, when the equivalent beam direction (\hat{θ}ₑ,\hat{φ}ₑ) is updated and becomes equal to the pointing error (\hat{θ}ₑ,\hat{φ}ₑ) of the mechanical adjustment, the overall beam direction (\hat{θ}ₒ,\hat{φ}ₒ) of the antenna 10 can point toward the target satellite 20.

$$Accordingly ,$$

$$( {\hat{θ}}_{e} , {\hat{ϕ}}_{e} ) = f ( {\hat{α}}_{r x} , {\hat{β}}_{r x} , {\hat{γ}}_{r x} ) = ( {θ}_{e} , {ϕ}_{e} ) = ( {\hat{θ}}_{m} - {θ}_{ZOA}^{′} , {\hat{ϕ}}_{m} - {ϕ}_{AOa}^{′} ) = ( π / 2 - {θ}_{ZOA}^{′} , - {ϕ}_{AOA}^{′} ) = ( π / 2 - {\hat{θ}}_{o} , - {\hat{ϕ}}_{o} ) .$$

$$Eventually ,$$

$$( {\hat{θ}}_{o} , {\hat{ϕ}}_{o} ) = ( {θ}_{ZOA}^{′} , {ϕ}_{AOA}^{′} ) = ( π / 2 - {\hat{θ}}_{e} , 0 - {\hat{ϕ}}_{e} ) = ( {\hat{θ}}_{m} - {\hat{θ}}_{e} , {\hat{ϕ}}_{m} - {\hat{ϕ}}_{e} ) = f ( {\hat{α}}_{rx} , {\hat{β}}_{rx} , {\hat{γ}}_{rx} ) .$$

In summary, the hybrid beam tracking involves both mechanical and electrical adjustments. During mechanical adjustment, the incoming path direction 22 of the target satellite 20 relative to the antenna broadside is a function of (\hat{α}ᵣₓ,\hat{β}ᵣₓ,\hat{γ}ᵣₓ), i.e., (θ′_{ZOA},φ′_{AOA})=f(\hat{α}ᵣₓ,\hat{β}ᵣₓ,\hat{γ}ᵣₓ). The antenna orientation determined by the mechanical triple-axis shaft (bearing, down-tilt, and slant) is (\hat{α}ᵣₓ,\hat{β}ᵣₓ,\hat{γ}ᵣₓ), the corresponding fixed beam direction is (\hat{θ}ₘ,\hat{φ}ₘ)≡(π/2, 0), and the pointing error is (θₑ,φₑ)=(\hat{θ}ₘ−θ′_{ZOA},\hat{φ}ₘ−φ′_{AOA}). During electrical adjustment, the electrical AOA phase shifter of the antenna 10 performs dynamic fine-tuning to obtain a beam direction (\hat{θ}ₑ,\hat{φ}ₑ) with a dynamic phase. The target overall beam direction is (\hat{θ}ₒ,\hat{φ}ₒ)=(θ′_{ZOA},φ′_{AOA}), and the condition for achieving this target is (\hat{θ}ₑ,\hat{φ}ₑ)=(θₑ,φₑ)=f(\hat{α}ᵣₓ,\hat{β}ᵣₓ,\hat{γ}ᵣₓ).

The fine beam tracking mechanism through electrical adjustment includes one-shot refinement and step-by-step refinement. The one-shot refinement is a beam tracking approach performed from an area outside the main beam, and the peak location (PL) of the beamforming output power in the one-shot refinement can be determined based on a subspace of a received signal (Rx) as part of a coarse tracking process, or calculated according to programmed tracking.

The step-by-step refinement is a beam tracking method performed within the area of the main beam (e.g., within a 3 dB beamwidth), and the peak location thereof is iteratively calculated based on a received signal strength indicator (RSSI).

Before describing the tracking scope (TS) for the hybrid beam tracking, several definitions are introduced for clarification. The current antenna orientation at time n is determined according to the mechanical triple-axis shaft (\hat{α}ₙ,\hat{γ}ₙ,\hat{γ}ₙ) of the antenna 10. A reference antenna orientation with respected to the antenna broadside direction 12 is defined as (α_{Ref},β_{Ref},γ_{Ref}), which corresponds to a previous antenna orientation from τ sampling points prior to the current time, wherein (α_{Ref},β_{Ref},γ_{Ref})=(\hat{α}_{n-τ},\hat{β}_{n-τ},\hat{γ}_{n-τ}), and τ represents the number of sampling points. This reference antenna orientation accounts for the current antenna orientation error introduced by mechanical adjustment, expressed as (αₑ,βₑ,γₑ)≡(\hat{α}ₙ,\hat{β}ₙ,\hat{γ}ₙ)−(α_{Ref},β_{Ref},γ_{Ref})=(\hat{α}ₙ−α_{Ref},\hat{β}ₙ−β_{Ref},\hat{γ}ₙ−γ_{Ref}).

Half of the fields-of-view (FoVs) of the bearing and down-tilt for fine bean tracking are defined as (A_{HF} and B_{HF}), and these parameters can be predetermined. It is noted that, for a target satellite 20 in geosynchronous Earth orbit (GEO), the slant angle is updated only through mechanical adjustment. However, for a target satellite 20 that is not in geosynchronous Earth orbit (non-GEO), the slant angle does not need to be updated.

The tracking mode and tracking scope are correspondingly classified as follows: a first tracking mode corresponds to a large-scale tracking scope 32; a second tracking mode corresponds to a medium-scale tracking scope 34; and a third tracking mode corresponds to a small-scale tracking scope 36.

The beam alignment of the dynamic hybrid beam tracking system for SATCOM, as shown in the preferred embodiment, can be dynamically determined based on a current reference antenna orientation stored in memory, a current antenna orientation updated via the mechanical triple-axis shaft, an incoming path direction 22 of the target satellite 20 relative to the antenna broadside 12, a received signal strength indicator (RSSI), and predefined tracking modes and fields-of-view (FoVs) as described above.

The first tracking mode features a large-scale tracking scope 32 with coarse beam tracking at a first sampling rate. Specifically, when the difference between the reference antenna orientation stored in memory and the current antenna orientation updated by the mechanical triple-axis shaft exceeds a first predefined field-of-view (FoV), beam alignment is achieved through mechanical adjustment using the mechanical triple-axis shaft.

Within the large-scale tracking scope 32 of the first tracking mode, if B_{HF}≤|βₑ| or A_{HF}≤|αₑ|, where αₑ represents a bearing orientation error, βₑ represents a down-tilt orientation error, and B_{HF} and A_{HF} respectively represent half of the predefined field-of-view (FoV) for fine beam tracking along the down-tilt axis β and bearing axis α, and are determined based on a signal-to-noise ratio (SNR) (for example: B_{HF}=15°, A_{HF}=10°), then the operation is determined to belong to the large-scale tracking scope 32 of the first tracking mode. In such case, coarse beam tracking is performed according to the first tracking procedure, i.e., mechanical adjustment using the mechanical triple-axis shaft at the first sampling rate.

The second tracking mode features a medium-scale tracking scope 34 with fine beam tracking at the first sampling rate. Specifically, when the difference between the reference antenna orientation stored in memory and the current antenna orientation updated by the mechanical triple-axis shaft is less than the first predefined field-of-view (FoV) but greater than a second predefined field-of-view (FoV), beam alignment is achieved through electrical adjustment using programmed tracking for beam pointing.

Within the medium-scale tracking scope 34 of the second tracking mode, if B_{H3dB}≤|βₑ|<B_{HF} or A_{H3dB}≤|αₑ|<A_{HF}, where de represents a bearing orientation error, Be represents a down-tilt orientation error, and B_{H3dB} and A_{H3dB} respectively represent half of the 3 dB beamwidth Θ_{3dB} along the down-tilt axis β and the bearing axis α of the mechanical triple-axis shaft, these parameters are predetermined based on the corresponding beamwidth Θ_{3dB}, for example: B_{H3dB}=B_{3dB}/2, A_{H3dB}=A_{3dB}/2. When the second tracking mode is applied to a 32-element antenna array with B_{3dB}=A_{3dB}=3.16°, it is assumed that B_{H3dB}<B_{HF}.

The third tracking mode features a small-scale tracking scope 36 using fine beam tracking at a second sampling rate. Specifically, when the difference between the reference antenna orientation stored in memory and the current antenna orientation updated by the mechanical triple-axis shaft is less than a second predefined field-of-view (FoV), beam alignment is achieved through electrical adjustment using a step-tracking process for beam pointing.

Within the small-scale tracking scope 36 of the third tracking mode, |βₑ|<B_{H3dB} or |αₑ|<A_{H3dB}.

In the first tracking mode, mechanical coarse beam tracking is performed if the bearing orientation error satisfies A_{HF}≤|αₑ| or the down-tilt orientation error satisfies B_{HF}≤|βₑ|, or both conditions are satisfied simultaneously. In this mode, (αₑ,βₑ)=(\hat{α}ₙ−α_{Ref},\hat{β}ₙ−β_{Ref}). The current body attitude (μₙ, vₙ, ιₙ) of the antenna 10 is calculated based on signals received by a plurality of sensors at a corresponding sampling time n using the first sampling rate. The first sampling rate corresponds to a lower sampling rate. The antenna orientation (\hat{α}ₙ,\hat{β}ₙ,\hat{γ}ₙ) is determined according to an angle (∈ₙ, κₙ, ηₙ) between the target satellite 20 and the antenna 10, and the body attitude (μₙ, vₙ, ιₙ) of the antenna 10. Examples of the sensors include a gyroscope, an accelerometer, and a magnetometer.

In the mechanical adjustment portion of the first tracking mode, the mechanical triple-axis shaft of the antenna 10 is adjusted according to the current calculated antenna orientations (\hat{α}ₙ,\hat{γ}ₙ,\hat{γ}ₙ) to align the antenna beam as closely as possible with the target satellite 20. In the electrical adjustment portion of the first tracking mode, the electrical phase shifter is set to (\hat{θ}_{e,n},\hat{φ}_{e,n})=(π/2, 0), and the reference state (α_{Ref},β_{Ref},γ_{Ref}) stored in memory is updated to the current state (\hat{α}ₙ,\hat{γ}ₙ \hat{γ}ₙ).

In the second tracking mode, electrical fine beam tracking is performed if the bearing orientation error satisfies A_{H3dB}≤|αₑ|<A_{HF} or the down-tilt orientation error satisfies B_{H3DB}≤|βₑ|<B_{HF}, or both conditions are satisfied simultaneously. When checking is required, only the bearing orientation error and the down-tilt orientation error need to be checked, and checking of the slant orientation error is not required.

In the mechanical adjustment portion of the second tracking mode, the mechanical triple-axis shaft is set to (\hat{α}_{n-τ},\hat{γ}_{n-τ},\hat{γ}ₙ), wherein (\hat{α}_{n-τ},\hat{γ}_{n-τ}) represents the mechanical antenna orientation obtained from τ sampling points earlier and stored in memory. In other words, only the slant orientation \hat{γ}ₙ is updated, while the bearing direction a and down-tilt direction \hat{β} of the mechanical triple-axis shaft remain unchanged.

In the electrical adjustment portion of the second tracking mode, the electrical phase shifters (\hat{θ}_{e,n},\hat{φ}_{e,n}) are adjusted by one-step programmed tracking (\hat{θ}_{e,n},\hat{φ}_{e,n})=f(\hat{α}ₙ,\hat{γ}ₙ,\hat{γ}ₙ) according to (\hat{α}ₙ,\hat{β}ₙ \hat{γ}ₙ), such that the overall beam direction (\hat{θ}_{o,n},\hat{φ}_{o,n}) obtained by combining the mechanical and electrical adjustments can be aligned with the incoming path direction 22 (θ′_{ZOA}, φ′_{AOA}) of the target satellite 20, i.e., (\hat{θ}_{o,n},\hat{φ}_{o,n})=(θ′_{ZOA,n}, φ′_{AOA,n}). In this case, it is expected that (\hat{θ}_{e,n},\hat{φ}_{e,n})=(θ_{e,n},φ_{e,n})=(\hat{θ}ₘ−θ′_{ZOA,n},\hat{φ}ₘ−φ′_{AOA,n})=(π/2−θ′_{ZOA,n},−φ′_{AOA,n})=f(\hat{α}ₙ,\hat{γ}ₙ,\hat{γ}ₙ).

In the third tracking mode, electrical fine beam tracking is similarly performed if the bearing orientation error αₑ satisfies |αₑ|<A_{H3dB} or the down-tilt orientation error βₑ satisfies |βₑ|<B_{H3dB}, or both conditions are satisfied simultaneously. When checking is required, only the bearing orientation error de and the down-tilt orientation error βₑ need to be checked, and checking of the slant orientation error Ye is not required.

In the mechanical adjustment portion of the third tracking mode, the mechanical triple-axis shaft is set to (\hat{α}_{n-τ},\hat{β}_{n-τ},\hat{γ}ₙ), wherein (\hat{α}_{n-τ},\hat{β}_{n-τ}) represents the mechanical antenna orientation obtained from τ sampling points earlier and stored in memory. In other words, only the slant orientation \hat{γ}ₙ is updated, while the bearing a and down-tilt βdirections of the mechanical triple-axis shaft remain unchanged.

In the electrical adjustment portion of the third tracking mode, the antenna 10 dynamically adjusts the electrical phase shifter (\hat{θ}_{e,k},\hat{φ}_{e,k}) step by step at the higher second sampling rate corresponding to a sampling time k, based on the received signal power and the equivalent beam direction. Through the mechanical adjustment with a fixed phase (\hat{θ}ₘ,\hat{φ}ₘ)≡(π/2, 0), the overall beam direction (\hat{θ}_{o,k},\hat{φ}_{o,k}) obtained by combining the mechanical and electrical adjustments can be aligned with the incoming path direction of the target satellite 20, i.e., (\hat{θ}_{o,k},\hat{φ}_{o,k})=(θ′_{ZOA,n},φ′_{AOA,n}), wherein the second sampling rate is higher than the first sampling rate.

The present invention employs the first, second, and third tracking modes in conjunction with the first or second sampling rate, respectively, to activate rapid mechanical coarse adjustment when a large-scale error occurs, switch to electrical fine tracking after the error is reduced, and then perform step tracking at the higher second sampling rate. As a result, the overall response time is shortened, beam reacquisition time is reduced, and tracking speed and responsiveness are improved.

What is claimed is:

1. A dynamic hybrid beam tracking system for satellite communications,
wherein the system operates when an antenna of a user terminal located on the Earth's surface is in relative motion with a target satellite located in orbit, so as to dynamically perform hybrid beam tracking by the antenna to align a beam thereof with the target satellite;
wherein the dynamic hybrid beam tracking system is performed under a condition that the antenna establishes a connection with the target satellite through an initial search process, and dynamically determines beam tracking based on a current reference antenna orientation stored in memory, an antenna orientation updated through a mechanical triple-axis shaft of the antenna, an incoming path direction of the target satellite relative to an antenna broadside, a received signal strength indicator, and predefined tracking modes and fields-of-view;
wherein the tracking modes correspond to tracking scopes as follows:
a first tracking mode corresponds to a large-scale tracking scope, performing coarse beam tracking at a first sampling rate;
a second tracking mode corresponds to a medium-scale tracking scope, performing fine beam tracking at the first sampling rate; and
a third tracking mode corresponds to a small-scale tracking scope, performing fine beam tracking at a second sampling rate, the second sampling rate being higher than the first sampling rate;
and wherein the reference antenna orientation is determined according to three axes of the antenna, and the reference antenna orientation corresponds to a previous antenna orientation obtained t sampling points prior to a current time, t being a number of the sampling points.

2. The dynamic hybrid beam tracking system for satellite communications according to claim 1,
wherein, in the first tracking mode, when a difference between the reference antenna orientation and the antenna orientation updated by the mechanical triple-axis shaft exceeds a first predefined field-of-view, beam alignment is achieved through mechanical adjustment using the mechanical triple-axis shaft.

3. The dynamic hybrid beam tracking system for satellite communications according to claim 1,
wherein, within the large-scale tracking scope of the first tracking mode, αₑ represents a bearing orientation error, βₑ represents a down-tilt orientation error, B_{HF} and A_{HF} respectively represent half of a predefined field-of-view for fine beam tracking along the down-tilt axis and the bearing axis of the mechanical triple-axis shaft, and B_{HF} and A_{HF} are respectively determined based on a signal-to-noise ratio;
and wherein, if B_{HF}≤|βₑ| or A_{HF}≤|αₑ| is satisfied, the mechanical adjustment is performed using the mechanical triple-axis shaft at the first sampling rate.

4. The dynamic hybrid beam tracking system for satellite communications according to claim 3,
wherein
$${B}_{H F} = 15 ° and {A}_{H F} = 10 ° .$$

5. The dynamic hybrid beam tracking system for satellite communications according to claim 1,
wherein, in the second tracking mode, when a difference between the reference antenna orientation and the antenna orientation updated by the mechanical triple-axis shaft is less than the first predefined field-of-view but greater than a second predefined field-of-view, beam alignment is achieved through electrical adjustment using programmed tracking.

6. The dynamic hybrid beam tracking system for satellite communications according to claim 5,
wherein, within the medium-scale tracking scope of the second tracking mode, de represents a bearing orientation error, Be represents a down-tilt orientation error, and B_{H3dB} and A_{H3dB} respectively represent half of a 3 dB beamwidth along the down-tilt axis and the bearing axis direction of the mechanical triple-axis shaft;
and wherein, if B_{H3dB}≤|βₑ|<B_{HF} or A_{H3dB}≤|αₑ|<A_{HF} is satisfied, B_{H3dB} and A_{H3dB} are predetermined based on the corresponding beamwidth.

7. The dynamic hybrid beam tracking system for satellite communications according to claim 6,
wherein
$${B}_{H 3 d B} = {B}_{3 d B} / 2 and {A}_{H 3 d B} = {A}_{3 d B} / 2 .$$

8. The dynamic hybrid beam tracking system for satellite communications according to claim 7,
wherein, when the second tracking mode is applied in a 32-element antenna array, B_{3dB}=A_{3dB}=3.16°.

9. The dynamic hybrid beam tracking system for satellite communications according to claim 1,
Wherein, in the third tracking mode, αₑ represents a bearing orientation error, βₑ represents a down-tilt orientation error, and B_{H3dB} and A_{H3dB} respectively represent half of a 3 dB beamwidth along the down-tilt axis and the bearing axis direction of the mechanical triple-axis shaft;
and wherein, if the bearing orientation error satisfies |αₑ|<A_{H3dB} or the down-tilt orientation error satisfies |βₑ|<B_{H3dB}, electrical fine beam tracking is performed.
